(19) United States
(12) Patent Application Publication
(10) Pub. No.: US 2010/0154024 A1
(43) Pub. Date: Jun. 17, 2010

(54) METHODS, APPLIANCES, AND COMPUTER PROGRAM PRODUCTS FOR CONTROLLING ACCESS TO A COMMUNICATION NETWORK BASED ON POLICY INFORMATION

(75) Inventors: James Boxmeyer, Flemington, NJ (US); David Gross, South River, NJ (US); John Hogoboom, Boonton, NJ (US)

Correspondence Address: AT&T Legal Department - MB;Attn: Patent Docketing, Room 2A-207, One AT&T Way, Bedminster, NJ, 07921, US

(73) Assignee: AT&T Intellectual Property I, L.P.

(21) Appl. No.: 12/334,002

(22) Filed: Dec. 12, 2008

(51) Int. Cl. G06F 21/00

(52) U.S. Cl. 726/1

(57) ABSTRACT

A method of operating an appliance in a communication network includes receiving policy information associated with at least one network access account from a responsible party associated with the account, the policy information restricting and/or expanding allowable use of the communication network, and controlling access to the communication network based on the received policy information.

### BACKGROUND

The present disclosure relates generally to communication networks and devices that operate thereon, and, more particularly, to controlling access to a communication network.

Communications networks are widely used for nationwide and worldwide communication of voice, multimedia and/or data. As used herein, communications networks include public communications networks, such as the Public Switched Telephone Network (PSTN), terrestrial and/or satellite cellular networks and/or the Internet.

The Internet is a decentralized network of computers that can communicate with one another via Internet Protocol (IP). The Internet includes the World Wide Web (WWW) service facility, which is a client/server-based facility that includes a large number of servers (computers connected to the Internet) on which Web pages or files reside, as well as clients (Web browsers), which interface users with the Web pages. The topology of the World Wide Web can be described as a network of networks, with providers of network services called Network Service Providers, or NSPs. Servers that provide application-layer services may be referred to as Application Service Providers (ASPs). Sometimes a single service provider provides both functions.

In today's increasingly complex Internet environment, however, users do not have a convenient way to regulate and control access to Internet applications, such as, for example, chat, online gaming, peer-to-peer communication, and/or Voice over Internet Protocol (VoIP) communication. Conventional software solutions typically address this problem locally at the user's computer or network access device, but the access control mechanisms can often be easily subverted, especially in an era where the technical expertise of children may exceed that of the Internet access account owner.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

Some embodiments provide a method of operating an appliance in a communication network including receiving policy information associated with at least one network access account from a responsible party associated with the account, the policy information restricting and/or expanding allowable use of the communication network, and controlling access to the communication network based on the received policy information.

In other embodiments, the policy information specifies a total amount of time that the communication network is allowed to be accessed within a specified time period.

In still other embodiments, the policy information specifies at least one time period that the communication network is allowed to be accessed and/or at least one time period that the communication network is not allowed to be accessed.

In still other embodiments, the policy information specifies at least one application that is allowed to be run via the communication network and/or at least one application that is not allowed to be run via the communication network.

In still other embodiments, the policy information specifies at least one category of applications that is allowed to be run via the communication network and/or at least one category of applications that is not allowed to be run via the communication network.

In still other embodiments, the policy information specifies an access code to be entered by a user for accessing the communication network.

In still other embodiments, receiving the policy information includes receiving a user selection of a policy information template, the policy information template comprising policy information that specifies at least one application that is allowed to be run via the communication network, at least one application that is not allowed to be run via the communication network, and/or at least one time limitation for accessing the communication network.

In still other embodiments, the method further includes generating a report associating statistics for traffic on the communication network with the received policy information.

In still other embodiments, the policy information is further associated with at least one client device used to access the communication network.

In further embodiments, an appliance for use in a communication network includes a user interface module that is configured to receive policy information associated with at least one network access account from a responsible party associated with the account, the policy information restricting and/or expanding allowable use of the communication network, and an access control module that is configured to control access to the communication network based on the received policy information.

In still further embodiments, the user interface module is further configured to receive a user selection of a policy information template, the policy information template comprising policy information that specifies at least one application that is allowed to be run via the communication network, at least one application that is not allowed to be run via the communication network, and/or at least one time limitation for accessing the communication network.

In still further embodiments, the appliance includes a traffic report module that is configured to generate a report associating statistics for traffic on the communication network with the received policy information.

In other embodiments, a computer program product for operating an appliance in a communication network includes a computer readable storage medium having computer readable program code embodied therein. The computer readable program code includes computer readable program code configured to receive policy information associated with at least one network access account from a responsible party associated with the account, the policy information restricting and/or expanding allowable use of the communication network, and computer readable program code configured to control access to the communication network based on the received policy information.

In still other embodiments, the computer readable program code configured to receive policy information comprises computer readable program code configured to receive a user selection of a policy information template, the policy information template comprising policy information that specifies at least one application that is allowed to be run via the communication network, at least one application that is not allowed to be run via the communication network, and/or at least one time limitation for accessing the communication network.

In still other embodiments, the computer program product further comprises computer readable program code configured to generate a report associating statistics for traffic on the communication network with the received policy information.

Other methods, systems, devices, appliances, and/or computer program products according to embodiments of the invention will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

Other features of exemplary embodiments will be more readily understood from the following detailed description of specific embodiments thereof when read in conjunction with the accompanying drawings, in which:

FIG. 1 is a block diagram that illustrates a client-server environment in accordance with some embodiments;

FIG. 2 is a block diagram that illustrates a communication network architecture in which policy information is used to control access to the network in accordance with some embodiments;

FIG. 3 is a block diagram that illustrates a client device/mobile terminal in accordance with some embodiments;

FIG. 4 is a block diagram that illustrates a software/hardware architecture for a network access control appliance in accordance with some embodiments;

FIG. 5 is a user interface screen for generating policies for controlling access to a communication network in accordance with some embodiments; and

FIG. 6 is a flowchart that illustrates operations controlling access to a communication network based on policy information in accordance with some embodiments.

### DETAILED DESCRIPTION

While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise. It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments may be embodied as methods, systems, devices and/or computer program products. Accordingly, exemplary embodiments may be embodied in hardware and/or in software (including firmware, resident software, micro-code, etc.). Furthermore, exemplary embodiments may take the form of a computer program product comprising a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

As used herein, the term “mobile terminal” may include a satellite or cellular radiotelephone with or without a multi-line display; a Personal Communications System (PCS) terminal that may combine a cellular radiotelephone with data processing, facsimile and data communications capabilities; a PDA that can include a radiotelephone, pager, Internet/intranet access, Web browser, organizer, calendar and/or a global positioning system (GPS) receiver; and a conventional laptop and/or palmtop receiver or other appliance that includes a radiotelephone transceiver. Mobile terminals may also be referred to as “pervasive computing” devices.

For purposes of illustration, some embodiments are described herein in the context of a client device being a mobile terminal. It will be understood, however, that the present invention is not limited to such embodiments and that a client device may be embodied as any electronic device that is capable of accessing a network, such as the Internet, via a network access control appliance as described below. Moreover, some embodiments are described with reference to the network access control appliance controlling the access of client devices to the Internet. It will be understood that the present invention is not limited to controlling access to the Internet, but is applicable generally to any type of communication network for which it may be desired to limit access thereto.

According to some embodiments, an owner of or responsible party for an account for accessing a network, such as the Internet, may regulate the amount of time and/or type of activity that users of the account are allowed to engage in. In some embodiments, for example, the party responsible for the account may setup specific policies for the account to allow or deny certain types of activity by users of the account and/or limit access to certain types of activity to specific times of day. In this regard, the responsible party may setup policies that restrict and/or expand allowable use of the network via the account. For example, in some embodiments, it may be desirable to expand allowable use for a particular purpose, such as a child that may need to download a particular file for use in a school project. In some embodiments, an access control appliance may be placed between client devices and the network to serve as a gateway for accessing the network using a particular account. The access control appliance may use policy information setup by the party responsible for an account to control network access for that account. The policy information may be configured using a relatively simple to understand interface without the need for complicated network terms and/or an extensive knowledge of the Internet, for example. The policy information may include access schedules for individual applications, and/or categories of applications. For example, access to the category of online gaming applications may be limited to 6 PM-8 PM on weekends. Unlike conventional approaches where access control is implemented at a client device, the access control appliance according to some embodiments may be placed in the network cloud and not bound to any particular client device and/or operating system. In addition, multiple user devices that are used to access a particular account can be managed from a central location. A policy may apply universally to any client device accessing the network through a particular account or a policy may be designed that is specific for one or more client devices. Embodiments are not limited to any particular type of client device used to access the network and may include both wireline and wireless devices. The access control appliance may also be configured to present the party responsible for the account with a standard set of policy templates that cover common categories of applications. As new applications are created, they can be added to existing categories or new categories created. In addition, the party responsible for the account may define custom policies for specific applications or Web sites. In some embodiments, the access control appliance may provide a traffic report that illustrates network usage based upon the policies that are being enforced.

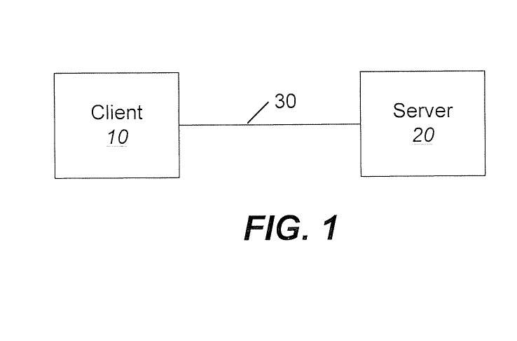

Exemplary embodiments can operate in a logically separated client side/server side-computing environment, sometimes referred to hereinafter as a client/server environment. As shown in FIG. 1, a client 10 may communicate with a server 20 over a wireless and/or wireline communication medium 30. The client/server environment is a computational architecture that involves a client process (i.e., a client) requesting service from a server process (i.e., a server). In general, the client/server environment maintains a distinction between processes, although client and server processes may operate on different machines or on the same machine. Accordingly, the client and server sides of the client/server environment are referred to as being logically separated. Usually, when client and server processes operate on separate devices, each device can be customized for the needs of the respective process. For example, a server process can “run on” a system having large amounts of memory and disk space, whereas the client process often “runs on” a system having a graphic user interface provided by high-end video cards and large-screen displays.

A client can be a program, such as a Web browser, that requests information, such as web pages, from a server under the control of a user. Examples of clients include browsers such as Netscape Navigator® (America Online, Inc., Dulles, Va.) and Internet Explorer® (Microsoft Corporation, Redmond, Wash.). Browsers typically provide a graphical user interface for retrieving and viewing web pages, web portals, applications, and other resources served by Web servers. A SOAP client can be used to request web services programmatically by a program in lieu of a web browser. The applications provided by the service providers may execute on a server. The server can be a program that responds to the requests from the client. Some examples of servers are International Business Machines Corporation's family of Lotus Domino® servers, the Apache server and Microsoft's Internet Information Server (IIS) (Microsoft Corporation, Redmond, Wash.).

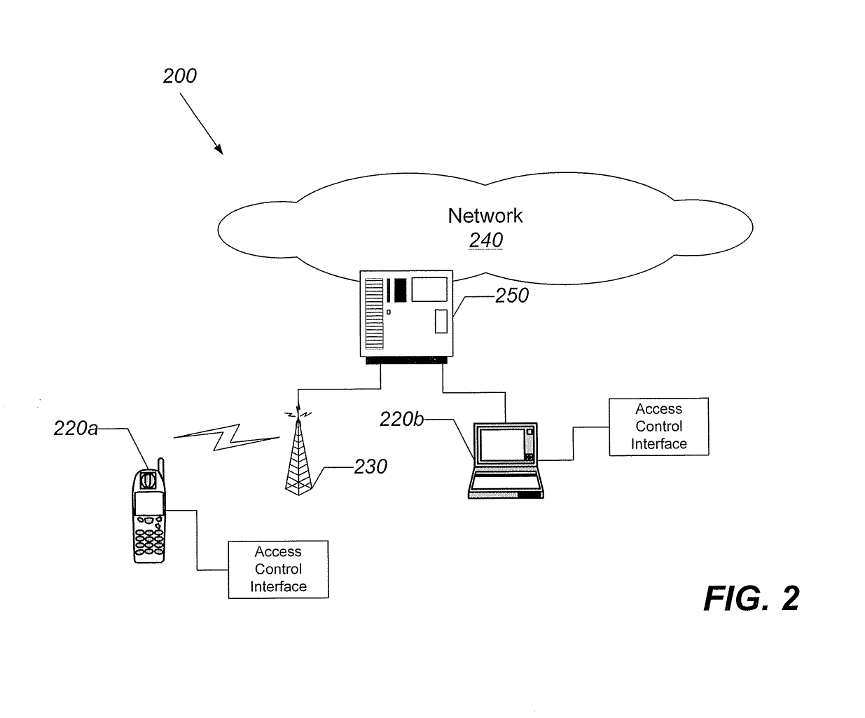

Referring now to FIG. 2, a network architecture 200 that facilitates controlling access to a communication network based on policy information, in accordance with some embodiments, includes client devices 220a and 220b that are coupled to a communication network 240 via a network access control appliance 250 as shown. A wireless base station transceiver 230 may facilitate wireless communication between the mobile client terminal 220a and the network access control appliance 250. Each of the client devices 220a and 220b include an access control interface module to allow the device to create and/or configure one or more policies for accessing the communication network 240 using a particular access account. The network access control appliance 250 may then control client device access to the communication network 240 for a particular account based on the one or more policies associated with the account as described in detail below. In accordance with various embodiments, the network access control appliance 250 may be configured between the client devices 220a, 220b and the communication network 240 and may serve as a gateway for accessing the communication network 240. The access control appliance 250 may be implemented as a single data processing system or a network of multiple data processing systems. The network 240 may represent a global network, such as the Internet, or other publicly accessible network. The network 240 may also, however, represent a wide area network, a local area network, an Intranet, or other private network, which may not accessible by the general public. Furthermore, the network 240 may represent a combination of public and private networks or a virtual private network (VPN). Moreover, client device 220a is described as a mobile terminal for purposes of illustrating some embodiments. It will be understood, however, that a client device may be embodied as any electronic device that is capable of accessing a network, such as the Internet, via the network access control appliance 250 as described herein. Thus, according to various embodiments, a client device may be a mobile terminal such as client device 220a, or may be relatively stationary, such as client device 220b.

Although FIG. 2 illustrates an exemplary communication network, it will be understood that the present invention is not limited to such configurations, but is intended to encompass any configuration capable of carrying out the operations described herein.

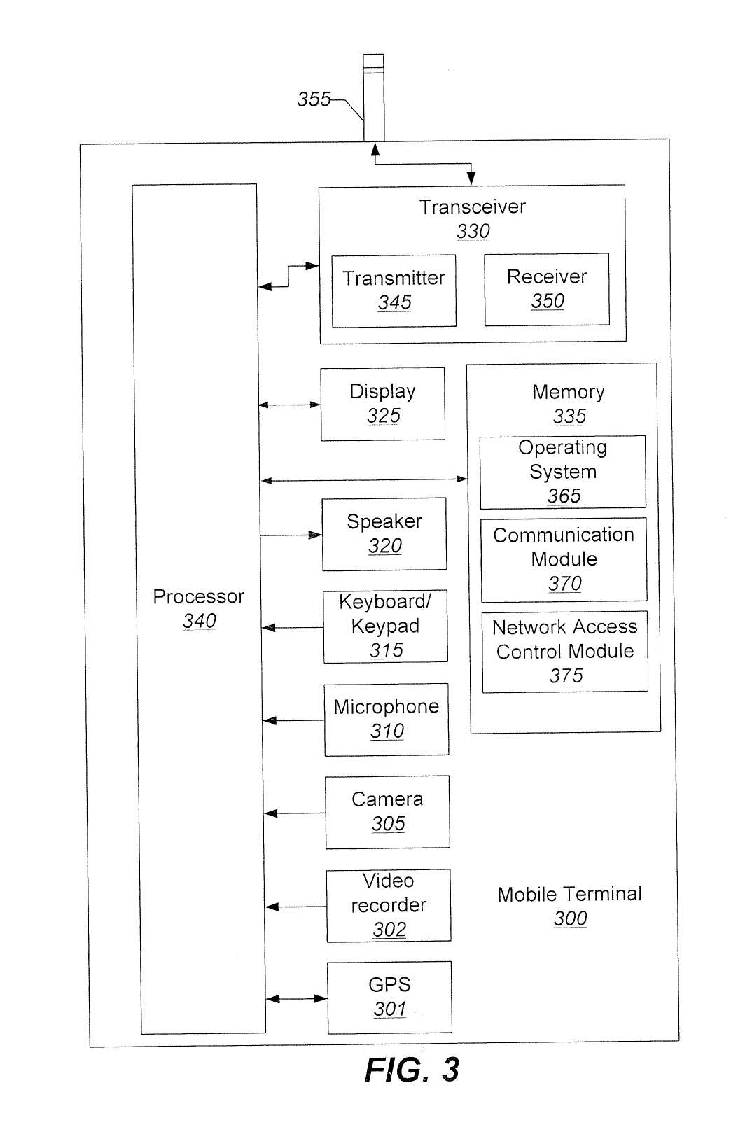

Referring now to FIG. 3, an exemplary mobile terminal 300 that may be used to implement a client device, such as client device 220a of FIG. 2, in accordance with some embodiments, includes a Global Positioning System (GPS) module 301, a video recorder 302, a camera 305, a microphone 310, a keyboard/keypad 315, a speaker 320, a display 325, a transceiver 330, and a memory 335 that communicate with a processor 340. The transceiver 330 comprises a transmitter circuit 345 and a receiver circuit 350, which respectively transmit outgoing radio frequency signals to base station transceivers and receive incoming radio frequency signals from the base station transceivers via an antenna 355. The radio frequency signals transmitted between the mobile terminal 300 and the base station transceivers may comprise both traffic and control signals (e.g., paging signals/messages for incoming calls), which are used to establish and maintain communication with another party or destination. The radio frequency signals may also comprise packet data information, such as, for example, cellular digital packet data (CDPD) information. The foregoing components of the mobile terminal 300 may be included in many conventional mobile terminals and their functionality is generally known to those skilled in the art.

The processor 340 communicates with the memory 335 via an address/data bus. The processor 340 may be, for example, a commercially available or custom microprocessor. The memory 335 is representative of the one or more memory devices containing the software and data used to operate the mobile terminal and to process location information received from, for example, a server device. The memory 335 may include, but is not limited to, the following types of devices: cache, ROM, PROM, EPROM, EEPROM, flash, SRAM, and DRAM.

As shown in FIG. 3, the memory 335 may contain three or more categories of software and/or data: the operating system 365, a communication module 370, and/or a network access control module 375. The operating system 365 generally controls the operation of the mobile terminal 300. In particular, the operating system 365 may manage the mobile terminal's software and/or hardware resources and may coordinate execution of programs by the processor 340. The communication module 370 may be configured to manage the communication protocols that are used to allow the mobile terminal 300 communicate with other devices and systems. The network access control module 375 may be configured to communicate with a user interface provided by the network access control appliance 250 (FIG. 2) to create and/or configure policies for controlling access to a communication network for an access account.

Although FIG. 3 illustrates an exemplary software and hardware architecture that may be used in a mobile client device it will be understood that the present invention is not limited to such a configuration, but is intended to encompass any configuration capable of carrying out the operations described herein.

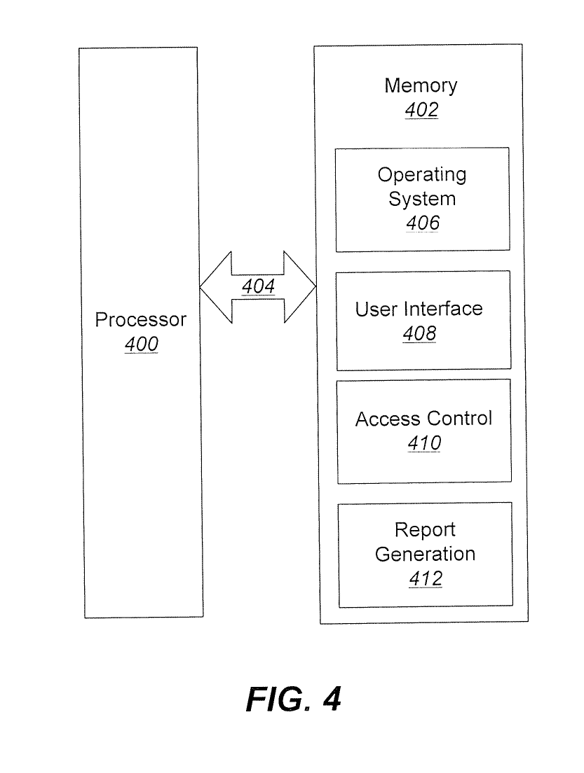

FIG. 4 illustrates a processor 400 and memory 402 that may be used in embodiments of data processing systems, such as the network access control appliance 250 of FIG. 2, for controlling user and/or client device access to a communication network based on policy information in accordance with some embodiments. The processor 400 communicates with the memory 402 via an address/data bus 404. The processor 400 may be, for example, a commercially available or custom microprocessor. The memory 402 is representative of the one or more memory devices containing the software and data used to control access to a communication network based on policy information in accordance with some embodiments. The memory 402 may include, but is not limited to, the following types of devices: cache, ROM, PROM, EPROM, EEPROM, flash, SRAM, and DRAM.

As shown in FIG. 4, the memory 402 may contain up to four or more categories of software and/or data: operating system(s) 406, a user interface module 408, an access control module 410, and a report generation module 412. The operating system 406 generally controls the operation of the data processing system. In particular, the operating system 406 may manage the data processing system's software and/or hardware resources and may coordinate execution of programs by the processor 400. The user interface module 408 may be configured to communicate with a network access control module 375 (FIG. 3) on a client device to create and/or configure one or more policies for accessing a communication network using a particular access account.

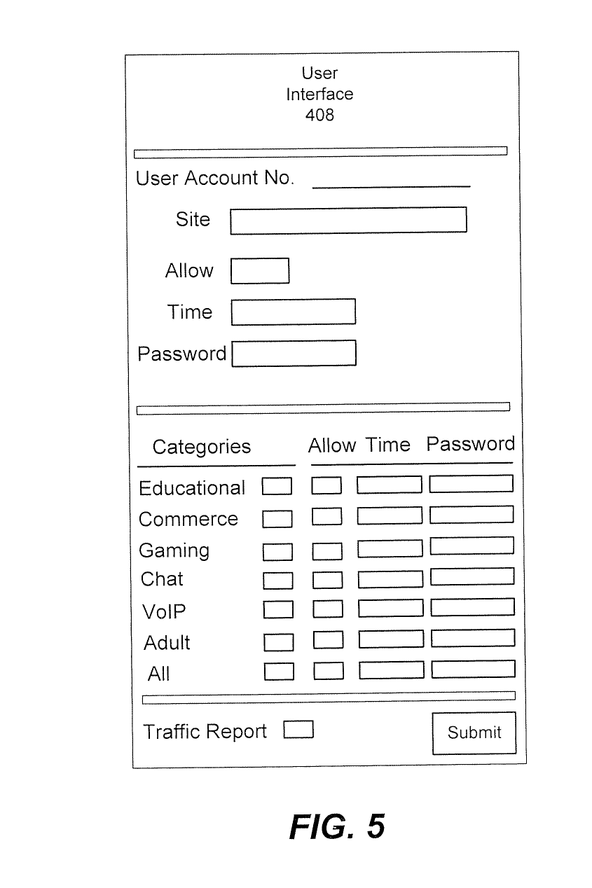

FIG. 5 illustrates a screen generated by the user interface 408 for creating and/or configuring communicating network access policies according to some embodiments. As shown in FIG. 5, a user can enter an account number for accessing a communication network, such as the Internet. In accordance with various embodiments, a user may have the option of creating one or more custom policies or selecting one or more standard policy templates with default values for configuring the network access control appliance 250 to control access to the communication network. For example, the user may enter the URL for a particular Web site, select whether to allow or deny access to that site, and also specify any time limitations for either allowing access or denying access to the site. The time limitations may be particular time periods, such as after 6 PM, between 9 AM and 5 PM, etc., and/or may include total cumulative time limits that the site can be accessed within a specified time period, such as not to exceed 10 hours in one week. A policy may also be associated with a particular client device through, for example, associating the policy with an IP address of the client device. Similarly, a policy may be associated with one or more specific users by associating a password with the policy. For example, to access a particular application a user may be required to enter a password or access code.

In addition to specific policies that can be designed for accessing individual Web sites, for example, the user interface 408 may provide policy information templates to assist a user in creating policies for various types of subject matter, applications, and the like. As shown in FIG. 5, policies have been created for six different categories with a seventh category entitled “All,” which applies to any type of communication network access. For each category, the user may specify whether access to such subject matter, applications, etc. is allowed or disallowed, any time limitations associated with the access, such as those described above, and/or whether a user is required to enter a password or access code to gain network access. As discussed above, the policy information templates associated with the various categories may be further associated with a particular client device through, for example, associating the template with an IP address of the client device.

Returning to FIG. 4, the access control module 410 may be configured to use the policies created, selected, and/or modified using the user interface module 408 to control access to a communication network. The report generation module 412 may generate a traffic report that illustrates network traffic statistics based on the access control policies that are in force for a user account in response to a request for such a report via the user interface 408 shown, for example, in FIG. 5.

Although FIG. 4 illustrates exemplary hardware/software architectures that may be used in data processing systems, such as the network access control appliance 250 shown in FIG. 2, for controlling access to a communication network based on policy information, it will be understood that the present invention is not limited to such a configuration but is intended to encompass any configuration capable of carrying out operations described herein. Moreover, the functionality of the network access control appliance 250 and the hardware/software architecture of FIG. 4 may be implemented as a single processor system, a multi-processor system, or even a network of stand-alone computer systems, in accordance with various embodiments of the present invention.

Computer program code for carrying out operations of data processing systems discussed above with respect to FIGS. 1-4 may be written in a high-level programming language, such as Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. Embodiments described herein, however, are not limited to any particular programming language. It will be further appreciated that the functionality of any or all of the program modules may also be implemented using discrete hardware components, one or more application specific integrated circuits (ASICs), or a programmed digital signal processor or microcontroller.

The exemplary embodiments described herein with reference to flowchart and/or block diagram illustrations of methods, devices, systems, and computer program products in accordance with exemplary embodiments. These flowchart and/or block diagrams further illustrate exemplary operations for controlling access to a communication network based on policy information, in accordance with some embodiments. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart and/or block diagram block or blocks.

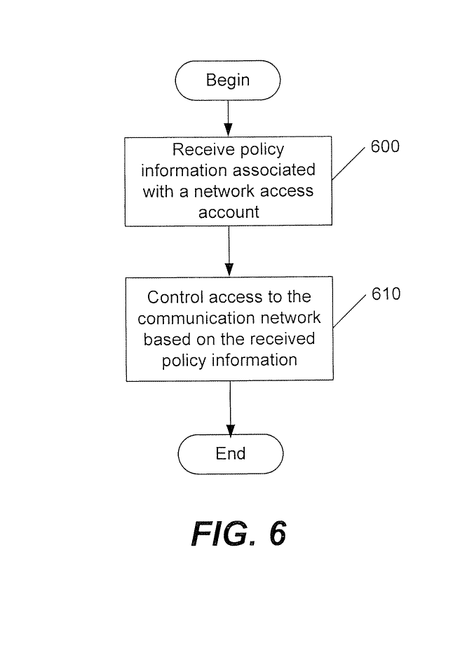

Referring now to FIG. 6, exemplary operations for controlling access to a communication network based on policy information begin at block 600 where the network access control appliance 250 receives policy information that is associated with a network access account. As described above, the network access control appliance 250 may receive the policy information from one or more client devices through a user interface 408. The network access control appliance 250 may then use the access control module 410 to control access to the communication network based on the received policy information at block 610. In this regard, the one or more policies may specify limitation(s) on what would otherwise be allowable use of the communication network. Thus, according to some embodiments, a network access account owner and/or a person that is responsible for a network account may administer a set of policies that limits the kind of content and/or applications that can be accessed via users of that access account along with any associated time of use restrictions. The policies may be tailored to specific user(s) and/or client devices. In addition to a standard set of policies that may be made available through policy information templates, new policies may be created and templates may be customized to create unique policies and enhance the level of control an owner has over the account.

The flowchart of FIG. 6 illustrates the architecture, functionality, and operations of some embodiments of methods, devices, systems, and computer program products for controlling access to a communication network based on policy information. In this regard, each block represents a module, segment, or portion of code, which comprises one or more executable instructions for implementing the specified logical function(s). It should also be noted that in other implementations, the function(s) noted in the blocks may occur out of the order noted in FIG. 6. For example, two blocks shown in succession may, in fact, be executed substantially concurrently or the blocks may sometimes be executed in the reverse order, depending on the functionality involved.

Many variations and modifications can be made to the preferred embodiments without substantially departing from the principles of the present invention. All such variations and modifications are intended to be included herein within the scope of the present invention, as set forth in the following claims.

That which is claimed:

1. A method of operating an appliance in a communication network, comprising:
receiving policy information associated with at least one network access account from a responsible party associated with the account, the policy information restricting and/or expanding allowable use of the communication network; and
controlling access to the communication network based on the received policy information.

2. The method of claim 1, wherein the policy information specifies a total amount of time that the communication network is allowed to be accessed within a specified time period.

3. The method of claim 1, wherein the policy information specifies at least one time period that the communication network is allowed to be accessed and/or at least one time period that the communication network is not allowed to be accessed.

4. The method of claim 1, wherein the policy information specifies at least one application that is allowed to be run via the communication network and/or at least one application that is not allowed to be run via the communication network.

5. The method of claim 1, wherein the policy information specifies at least one category of applications that is allowed to be run via the communication network and/or at least one category of applications that is not allowed to be run via the communication network.

6. The method of claim 1, wherein the policy information specifies an access code to be entered by a user for accessing the communication network.

7. The method of claim 1, wherein receiving the policy information comprises:
receiving a user selection of a policy information template, the policy information template comprising policy information that specifies at least one application that is allowed to be run via the communication network, at least one application that is not allowed to be run via the communication network, and/or at least one time limitation for accessing the communication network.

8. The method of claim 1, further comprising:
generating a report associating statistics for traffic on the communication network with the received policy information.

9. The method of claim 1, wherein the policy information is further associated with at least one client device used to access the communication network.

10. An appliance for use in a communication network, comprising:
a user interface module that is configured to receive policy information associated with at least one network access account from a responsible party associated with the account, the policy information restricting and/or expanding allowable use of the communication network; and
an access control module that is configured to control access to the communication network based on the received policy information.

11. The appliance of claim 10, wherein the policy information specifies a total amount of time that the communication network is allowed to be accessed within a specified time period.

12. The appliance of claim 10, wherein the policy information specifies at least one time period that the communication network is allowed to be accessed and/or at least one time period that the communication network is not allowed to be accessed.

13. The appliance of claim 10, wherein the policy information specifies at least one application that is allowed to be run via the communication network and/or at least one application that is not allowed to be run via the communication network.

14. The appliance of claim 10, wherein the policy information specifies at least one category of applications that is allowed to be run via the communication network and/or at least one category of applications that is not allowed to be run via the communication network.

15. The appliance of claim 10, wherein the policy information specifies an access code to be entered by a user for accessing the communication network.

16. The appliance of claim 10, wherein the user interface module is further configured to receive a user selection of a policy information template, the policy information template comprising policy information that specifies at least one application that is allowed to be run via the communication network, at least one application that is not allowed to be run via the communication network, and/or at least one time limitation for accessing the communication network.

17. The appliance of claim 10, further comprising:
a traffic report module that is configured to generate a report associating statistics for traffic on the communication network with the received policy information.

18. A computer program product for operating an appliance in a communication network, comprising:
a computer readable storage medium having computer readable program code embodied therein, the computer readable program code comprising:
computer readable program code configured to receive policy information associated with at least one network access account from a responsible party associated with the account, the policy information restricting and/or expanding allowable use of the communication network; and
computer readable program code configured to control access to the communication network based on the received policy information.

19. The computer program product of claim 18, wherein the computer readable program code configured to receive comprises computer readable program code configured to receive a user selection of a policy information template, the policy information template comprising policy information that specifies at least one application that is allowed to be run via the communication network, at least one application that is not allowed to be run via the communication network, and/or at least one time limitation for accessing the communication network.

20. The computer program product of claim 18, further comprising:
computer readable program code configured to generate a report associating statistics for traffic on the communication network with the received policy information.
